(19) United States
(12) Patent Application Publication
(10) Pub. No.: US 2015/0253765 A1
(43) Pub. Date: Sep. 10, 2015

(54) TEACHING JIG, TEACHING SYSTEM, AND TEACHING METHOD

(71) Applicant: KABUSHIKI KAISHA YASKAWA DENKI, Kitakyushu-shi (JP)

(72) Inventor: Shinichi KATSUDA, Fukuoka (JP)

(73) Assignee: KABUSHIKI KAISHA YASKAWA DENKI, Kitakyushu-shi (JP)

(21) Appl. No.: 14/631,847

(22) Filed: Feb. 26, 2015

(30) Foreign Application Priority Data
Mar. 4, 2014 (JP) 2014-042116

(51) Int. Cl. G05B 19/418; B25J 9/16

(52) U.S. Cl. CPC G05B 19/418; B25J 9/163; G05B 2219/45031; Y10S 901/03; Y10S 901/28

(57) ABSTRACT

A teaching jig includes a body portion and at least three light emitting units installed on the body portion. In the teaching jig, all the light emitting units are positioned, when the body portion is located at a target position of the teaching jig with respect to a measurement member and is seen over the measurement member, in the vicinity of a peripheral edge of the measurement member and at only one of the inside and the outside of the peripheral edge of the measurement member.

### CROSS-REFERENCE TO RELATED APPLICATION

The present disclosure contains subject matter related to that disclosed in Japanese Priority Patent Application No. 2014-042116 filed with the Japan Patent Office on Mar. 4, 2014, the entire contents of which are incorporated herein by reference.

### BACKGROUND OF THE INVENTION

1. Field of the Invention

An embodiment disclosed herein relates to a teaching jig, a teaching system, and teaching method.

2. Description of the Related Art

In the related art, there is known a teaching system that performs a teaching work of a transfer robot for transferring a substrate such as a semiconductor wafer or the like.

As one example of the teaching system, there is available a teaching system which includes a horizontal articulated robot having an end effector provided with an optical sensor at the tip thereof, and a teaching jig to be mounted to a container in pace of a substrate.

In this teaching system, the position of the teaching jig is detected by the optical sensor while moving the end effector, and the position of the substrate is taught to the transfer robot based on the position of the jig thus detected (see, e.g., International Patent Application Publication No. 2003/022534).

### SUMMARY OF THE INVENTION

In accordance with an aspect of the disclosure, there is provided a teaching jig which includes a body portion and at least three light emitting units installed on the body portion. In the teaching jig, all the light emitting units are positioned, when the body portion is located at a target position of the teaching jig with respect to a measurement member and is seen over the measurement member, in the vicinity of a peripheral edge of the measurement member and at only one of the inside and the outside of the peripheral edge of the measurement member.

### BRIEF DESCRIPTION OF THE DRAWINGS

FIG. 1 is a schematic view showing a teaching method which makes use of a teaching jig according to an embodiment.

FIG. 2 is a schematic view showing the arrangement of a teaching system.

FIG. 3A is a perspective view showing the configuration of a robot.

FIG. 3B is a perspective view showing the configuration of a hand.

FIG. 3C is a perspective view showing the configuration of a teaching jig.

FIG. 4 is a block diagram of the teaching system.

FIG. 5 is a perspective view showing the teaching jig located at a teaching position.

FIG. 6A is an explanatory view (a first explanatory view) for explaining a teaching method which makes use of a teaching jig according to a first modified example.

FIG. 6B is an explanatory view (a second explanatory view) for explaining the teaching method which makes use of the teaching jig according to the first modified example.

FIG. 6C is an explanatory view (a third explanatory view) for explaining the teaching method which makes use of the teaching jig according to the first modified example.

FIG. 6D is an explanatory view (a fourth explanatory view) for explaining the teaching method which makes use of the teaching jig according to the first modified example.

FIG. 7 is a perspective view showing a teaching jig according to a second modified example, which is located at a teaching position.

FIG. 8 is a perspective view showing a teaching jig according to a third modified example, which is located at a teaching position.

FIG. 9 is a flowchart illustrating a process sequence executed by the teaching system.

### DESCRIPTION OF THE EMBODIMENTS

An embodiment of a teaching jig, a teaching system and a teaching method disclosed herein will now be described in detail with reference to the accompanying drawings. The present disclosure is not limited to the embodiment to be described below.

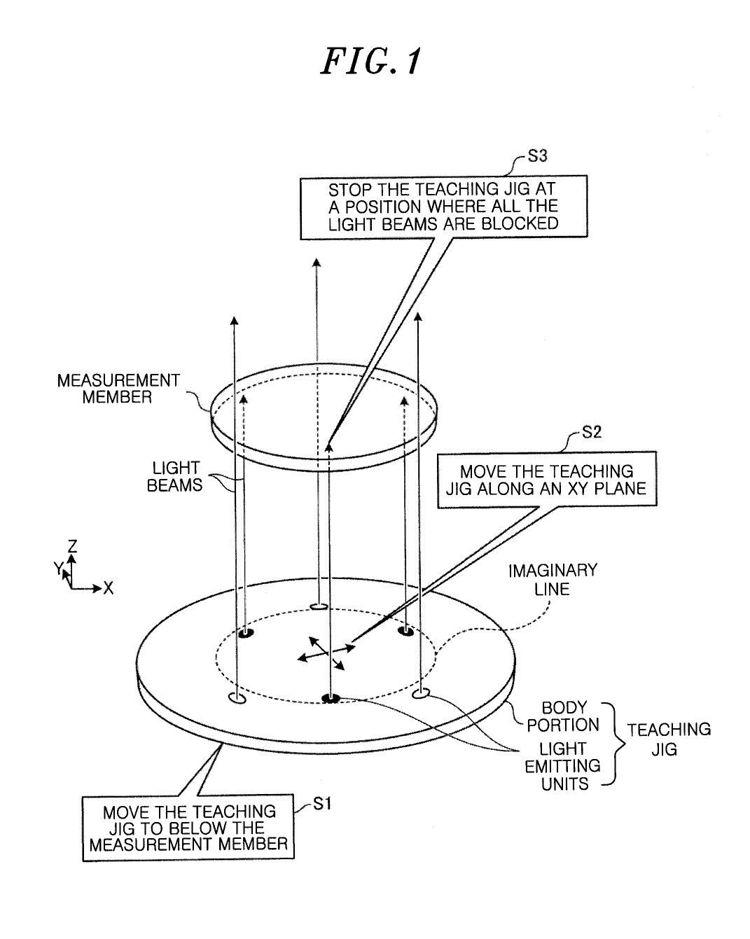

First, a teaching method which makes use of a teaching jig according to an embodiment will be described with reference to FIG. 1. The teaching method shown in FIG. 1 makes it possible to detect, using light beams emitted from light emitting units, that a teaching jig is located at an ideal target position (e.g., just below a measurement member). In FIG. 1, there is illustrated a case where the teaching jig is moved parallel to an XY plane shown in FIG. 1.

Furthermore, in FIG. 1, there is taken, as an example, a case where the teaching jig and the measurement member are discs. However, the shape of the teaching jig and the measurement member is not limited to a circular shape or a plate shape. As an example, the measurement member may have a three-dimensional shape such as a spherical shape or the like. The shape of the teaching jig does not matter as long as the teaching jig can hold light emitting units at specified positions.

As shown in FIG. 1, the teaching jig according to the embodiment includes a body portion and light emitting units installed in the body portion. The light emitting units irradiate light beams to the measurement member. The light emitting units are installed to lie, e.g., at only one of inner vicinity and outer vicinity of an imaginary line to be described below when the body portion is located at a target position with respect to the measurement member. That is, the light emitting units are positioned at respective predetermined distances from the imaginary line. In this case, the respective predetermined distances may be set depending on a required positioning accuracy of the teaching jig with respect to the measurement member. For instance, as the required positioning accuracy of the teaching jig with respect to the measurement member is higher, the predetermined distances may be set shorter. Further, as the required positioning accuracy of the teaching jig with respect to the measurement member is lower, the predetermined distances may be set longer. For example, the light emitting units may be installed so as to contact with the imaginary line at the inside or the outside thereof.

The term “imaginary line” used herein refers to a line corresponding to an peripheral edge of a region obtained by parallel projection of the measurement member on the teaching jig. That is to say, the imaginary line is a line which becomes a boundary between the outer edge of the measurement member and the teaching jig when the teaching jig is seen over the measurement member.

Referring to FIG. 1, three light emitting units are positioned in the inner vicinity of the imaginary line (see “black circles” in FIG. 1). In this case, if the teaching jig is positioned just below the measurement member, the light beams irradiated from all the three light emitting units are blocked by the measurement member. On the other hand, if the teaching jig is not positioned just below the measurement member, there exists at least one light emitting unit whose light beam is not blocked by the measurement member.

That is to say, when the three light emitting units are disposed in the inner vicinity of the imaginary line, the position at which all the light beams irradiated from the light emitting units are blocked by the measurement member becomes an ideal position of the teaching jig. In the teaching method according to the embodiment, this position is stored as a “teaching position”.

While the above description is directed to a case where the three light emitting units are positioned in the vicinity of the inner circumference of the imaginary line, the three light emitting units may be positioned in the vicinity of the peripheral edge of the imaginary line (see “white circles” in FIG. 1). In this case, if the teaching jig is located at the ideal position, any one of the light beams irradiated from the light emitting units is not blocked by the measurement member. On the other hand, if the teaching jig is shifted away from the ideal position, there exists at least one light emitting unit whose light beam is blocked by the measurement member.

With the teaching jig according to the embodiment is used, whether or not the teaching jig is located at a target ideal position can be easily detected by detecting whether the light beams of all the light emitting units are blocked. As described above, the teaching method according to the embodiment makes use of the teaching jig having the aforementioned arrangement of the light emitting units. It is therefore possible to easily and accurately perform alignment of the teaching jig with respect to the measurement member.

The teaching method which makes use of the teaching jig according to the embodiment will now be described in more detail. The following description will be made on a case where three light emitting units are positioned in the inner vicinity of the imaginary line (see “black circles” in FIG. 1).

As shown in FIG. 1, the teaching jig according to the embodiment is moved to below the measurement member (see step S1 in FIG. 1). In this step, the teaching jig may be moved based on rough position information of the measurement member. Then, the teaching jig is moved parallel to an XY plane shown in FIG. 1 (see step S2 in FIG. 1). The light beams of the light emitting units are observed while repeating such movement.

The movement of the teaching jig is stopped at a position where the light beams irradiated from all the light emitting units are blocked by the measurement member (see step S3 in FIG. 1).

As described above, with the teaching jig according to the embodiment, the existence of the teaching jig at the ideal position can be easily and accurately detected depending on the detection that the light beams of all the light emitting units are blocked.

While the description made with reference to FIG. 1 is directed to a case where there are installed three light emitting units, the number of the light emitting units is not limited thereto and may be an arbitrary number of four or more. If the light emitting units are disposed at an equal interval, it is possible to further increase the accuracy of measurement of the position of the teaching jig. For example, the light emitting units may be disposed such that the area of a polygon formed by interconnecting the positions of the light emitting units becomes larger.

Further, although irradiation directions of the light beams of the light emitting units are perpendicular to a surface of the teaching jig, the irradiation directions of the light beams of the light emitting units are not limited thereto. The irradiation directions of the light beams of the light emitting units may be in an arbitrary direction as long as the light beams are parallel to one another. That is, it is preferred that the light beams irradiated from all the light emitting units have identical directivity.

Next, description is made on a teaching system in which the teaching jig is held by a hand of a robot which will be described later. This makes it possible to efficiently perform a teaching work for the robot.

The following description will be made by taking, as an example, a case where the teaching position is a position of the hand which gives and receives a wafer to and from a FOUP (Front Opening Unified Pod). However, the teaching position is not limited thereto and may be an arbitrary location within an operation range of the robot.

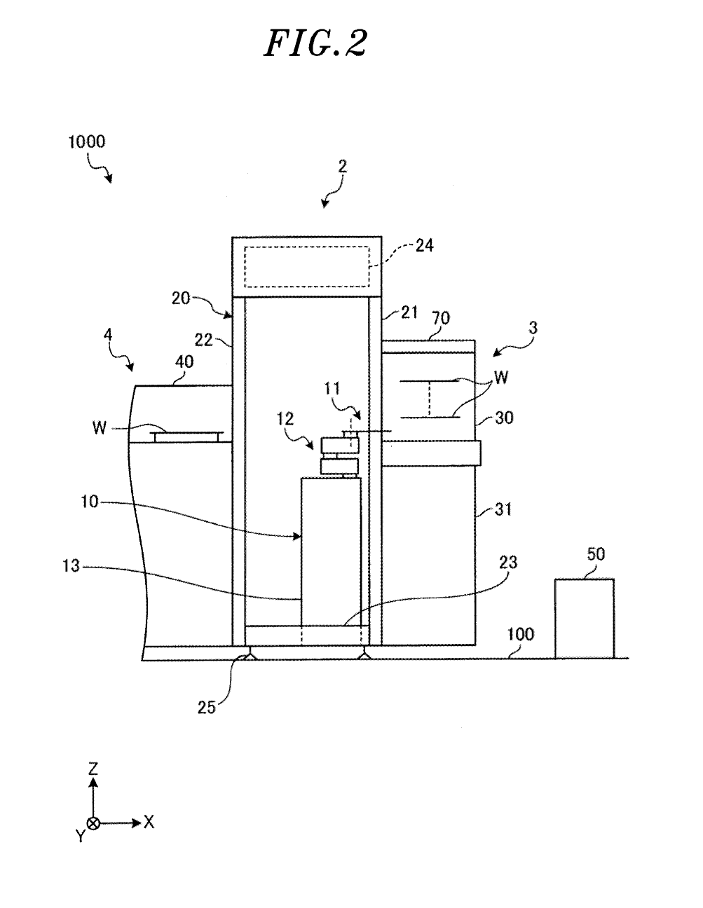

FIG. 2 is a schematic view showing the arrangement of a substrate processing system 1000 to which the teaching system according to the present embodiment is applied. For the sake of making the description readily understandable, a three-dimensional rectangular coordinate system including a Z-axis whose positive direction extend vertically upward and whose negative direction extends vertically downward (namely, in a “vertical direction”) is indicated in FIG. 1. The direction extending along an X-Y plane designates a “horizontal direction”. This rectangular coordinate system will be sometimes indicated in other drawings used in the following description. In some cases, the positive direction of the Z-axis with respect to an object will be referred to as an upper side, and the negative direction of the Z-axis will be referred to as a lower side.

In the following description, it is sometimes the case that only some of a plurality of components are designated by reference symbols with the remaining components not given any reference symbol. In this case, it is assumed that some of the components accompanying reference symbols are identical in configuration with the remaining components.

Furthermore, it is sometimes the case that a plurality of identical components is identified by giving an additional reference numeral in the form of “-number” to the reference symbol of the components. In this case, when generically designating the components, only the reference symbol is used without using the additional reference numeral in the form of “-number”.

As shown in FIG. 2, the substrate processing system 1000 includes a substrate transfer part 2, a substrate supply part 3 and a substrate processing part 4. The substrate transfer part 2 includes a robot 10 and a housing 20 within which the robot 10 is disposed. The substrate supply part 3 is installed on one side surface 21 of the housing 20. The substrate processing part 4 is installed on the other side surface 22 of the housing 20. In FIG. 2, there is also shown an installation surface 100 of the substrate processing system 1000.

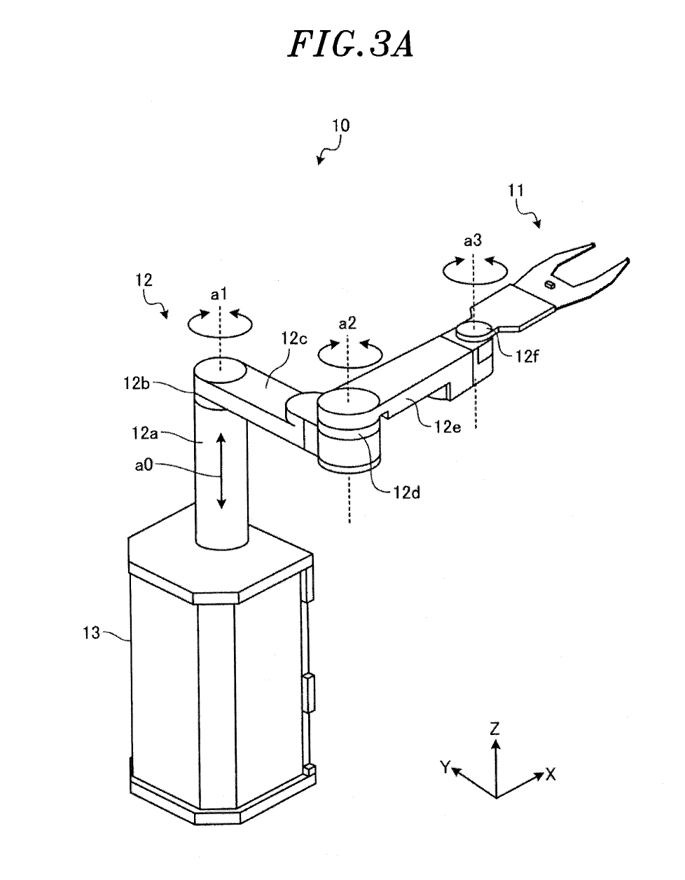

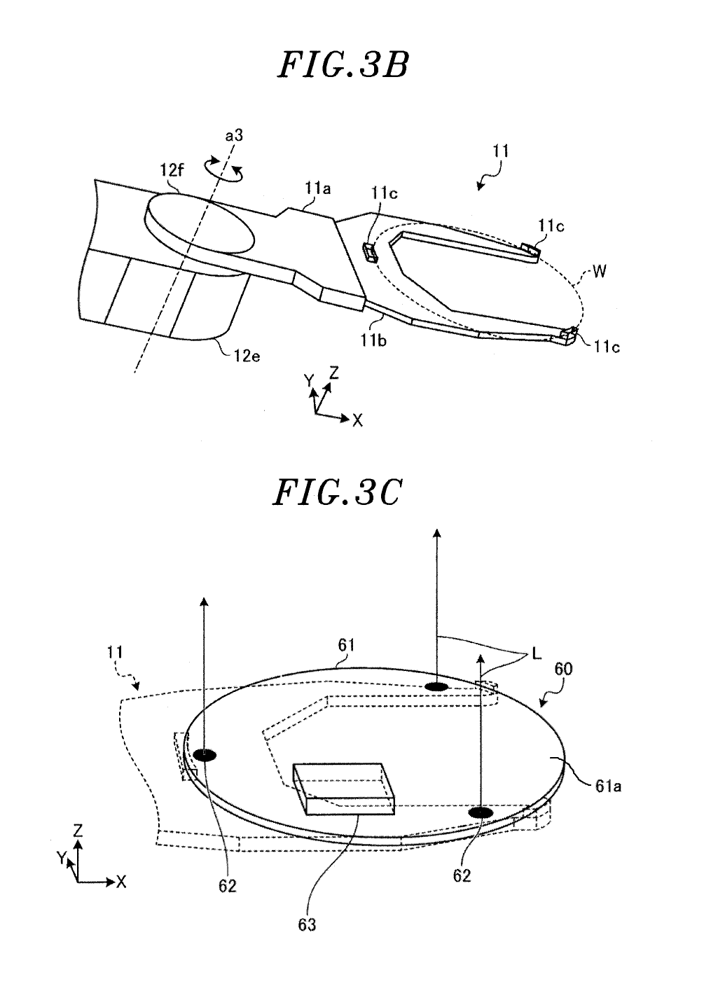

The robot 10 includes an arm unit 12 which has a hand 11 capable of holding a wafer W as a transfer target object. The arm unit 12 is vertically movable and horizontally swingably supported by a base 13 installed on a base installation frame 23 which forms a bottom portion of the housing 20. Details of the robot 10 will be described later with reference to FIG. 3A.

The housing 20 is a so-called EFEM (Equipment Front End Module). A down-flow of a clean air is formed through a filter unit 24 installed in an upper portion of the housing 20. The interior of the housing 20 is kept in a highly clean state by virtue of the down-flow. Legs 25 are installed on a lower surface of the base installation frame 23 so as to support the housing 20 with a specified gap left between the housing 20 and the installation surface 100.

The substrate supply part 3 includes a FOUP 30 which accommodates a plurality of wafers W (corresponding to the measurement member shown in FIG. 1) at multiple stages along a height direction and a FOUP opener (not shown) which opens and closes a lid of the FOUP 30 so that each of the wafers W can be taken out from the FOUP 30 into the housing 20. Multiple sets of the FOUP 30 and the FOUP opener may be installed side by side at a specified interval on a table 31 having a predetermined height.

For example, a detection unit 70 is installed above the FOUP 30. The detection unit 70 is an optical detection device such as an optical sensor or the like and is installed such that a light receiving unit thereof is oriented in, e.g., a Z-axis negative direction. In the present embodiment, information on the measurement light beams L to be described later with reference to FIG. 3C is acquired based on the detection data of the detection unit 70. The detection unit 70 is not limited to the optical detection device. An imaging device having a specified imaging region may be used as the detection unit 70. Alternatively, the light detection may be performed with eyes instead of the detection unit 70.

The substrate processing part 4 is a processing part which performs specified semiconductor manufacturing processes, e.g., a cleaning process, a film forming process and a photolithography process, with respect to the wafer W. The substrate processing part 4 includes a processing apparatus 40 which implements the specified processes. The processing apparatus 40 is disposed on the other side surface 22 of the housing 20 such that, for example, the processing apparatus 40 faces the substrate supply part 3 across the robot 10.

In FIG. 2, there is shown a case where the substrate supply part 3 and the substrate processing part 4 are disposed so as to face each other. However, this is not intended to limit the positional relationship between the substrate supply part 3 and the substrate processing part 4. For example, the substrate supply part 3 and the substrate processing part 4 may be disposed on one side surface of the substrate transfer part 2 or may be disposed on two non-facing side surfaces of the substrate transfer part 2. In other words, the substrate supply part 3 and the substrate processing part 4 may be disposed in an arbitrary positional relationship.

Within the housing 20, there is installed a pre-aligner device (not shown) which performs centering and notch aligning of the wafer W. The substrate processing system 1000 further includes a control device 50 installed outside the housing 20. The control device 50 is connected to various kinds of devices such as the robot 10, the detection unit 70 and the like in such a manner that can communicate with each of them.

In the substrate processing system 1000, the robot 10 takes out the wafer W from the FOUP 30 while making an up/down operation and a swing operation and loads the wafer W into the processing apparatus 40 via the pre-aligner device (not shown). Then, the wafer W subjected to a specified process in the processing apparatus 40 is unloaded and transferred by the robot 10. The wafer W is accommodated within the FOUP 30 again.

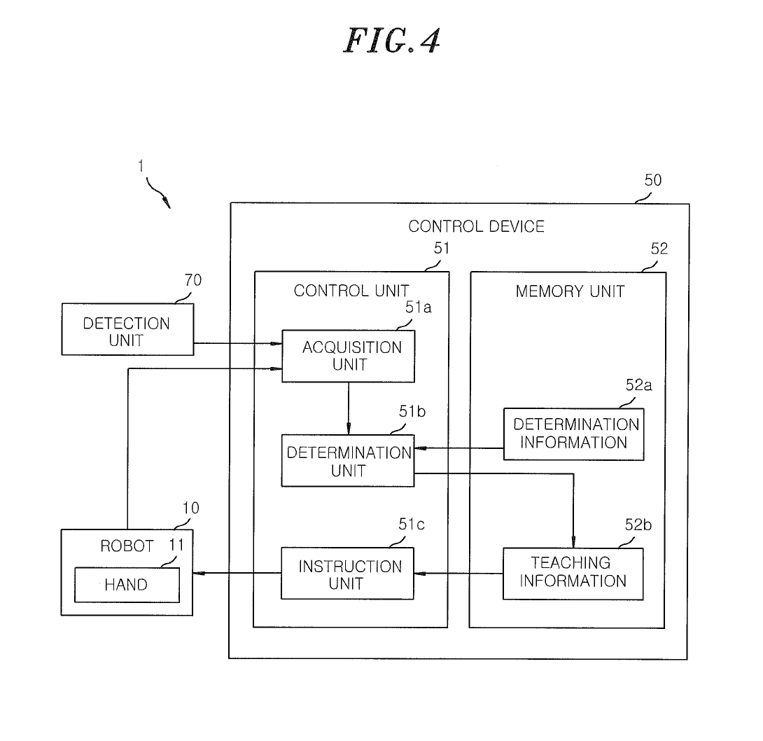

The control device 50 is a controller which controls operations of various kinds of devices connected thereto. The control device 50 includes a control unit, an arithmetic processing unit, a storage unit, and so forth. Details of the control device 50 will be described later with reference to FIG. 4.

In FIG. 2, there is shown the control device 50 installed in a single housing. As an alternative example, the control device 50 may include a plurality of control devices, which are accommodated in the respective housings, corresponding to various kinds of devices to be controlled. Alternatively, the control device 50 may be disposed within the housing 20.

The control device 50 may control various operations of the robot 10 based on teaching data previously stored in the control device 50. The teaching data may be acquired from a host device (not shown) which is connected to the control device 50 in a mutually communicating manner. In this case, the host device can monitor the status of the robot 10 (and the respective components thereof).

Next, the configuration of the robot 10 according to the embodiment will be described with reference to FIG. 3A. FIG. 3A is a perspective view showing the configuration of the robot 10. As shown in FIG. 3A, the robot 10 includes a hand 11, an arm unit 12 and a base 13. The arm unit 12 includes an elevator unit 12a, a joint unit 12b, a joint unit 12d, a joint unit 12f, a first arm 12c and a second arm 12e.

As described above, the base 13 is a base unit of the robot 10 installed on the base installation frame 23 (see FIG. 2). The elevator unit 12a is installed so as to slide in the vertical direction (Z-axis direction) with respect to the base 13 (see a double-head arrow a0 in FIG. 3A) and is configured to move the arm unit 12 up and down along the vertical direction.

The joint unit 12b is a rotary joint for rotating about an axis a1 (see a double-head arrow around the axis a1 in FIG. 3A). The first arm 12c is swingably connected to the elevator unit 12a through the joint unit 12b.

The joint unit 12d is a rotary joint for rotating about an axis a2 (see a double-head arrow around the axis a2 in FIG. 3A). The second arm 12e is swingably connected to the first arm 12c through the joint unit 12d.

The joint unit 12f is a rotary joint for rotating about an axis a3 (see a double-head arrow around the axis a3 in FIG. 3A). The hand 11 is swingably connected to the second arm 12e through the joint unit 12f.

The robot 10 is equipped with drive power sources (not shown) such as motors or the like. The joint unit 12b, the joint unit 12d and the joint unit 12f are rotated by the drive power sources. The hand 11 is an end effector which holds the wafer W (see FIG. 2). The hand 11 is installed to have the axis a3 as a swing axis and can swing about the axis a3.

Next, details of the configuration of the hand 11 according to the embodiment will be described with reference to FIG. 3B. FIG. 3B is a perspective view showing the configuration of the hand 11. As shown in FIG. 3B, the hand 11 is installed at the tip portion of the second arm 12e through the joint unit 12f so as to rotate about the axis a3. The hand 11 includes a plate support portion 11a, a plate 11b and locking portions 11c.

The plate support portion 11a is connected to the joint unit 12f and is configured to support the plate 11b. That is to say, the plate 11b is a member corresponding to a base of the hand 11. In FIG. 3B, there is illustrated the plate lib having a bifurcated tip shape. However, this is not intended to limit the shape of the plate 11b.

The locking portions 11c are members which lock the wafer W and hold the wafer W on the hand 11. In the present embodiment, three locking portions 11c are provided in the positions shown in FIG. 3B and are configured to lock and hold the wafer W at three points. The number of the locking portions 11c is not limited to three and may be, e.g., four or more. In FIG. 3B, the wafer W held on the hand 11 is indicated by a dot line.

Next, the configuration of the teaching jig according to the embodiment will be described with reference to FIG. 3C. FIG. 3C is a perspective view showing the configuration of the teaching jig. In FIG. 3C, the hand 11 for holding the teaching jig 60 is indicated by a dot line. As shown in FIG. 3C, the teaching jig 60 includes a body portion 61 and light emitting units 62.

The body portion 61 is a plate-shaped body having a shape identical with the shape of the wafer W. At least three light emitting units 62 are installed in one of inner and outer vicinities of a peripheral edge of a major surface 61a of the body portion 61. In FIG. 3C, there is illustrated a case where the light emitting units 62 are installed at the inside of the peripheral edge. The following description will be made by taking this case as an example.

The light emitting units 62 irradiate measurement light beams L, e.g., in an upward direction perpendicular to the major surface 61a of the body portion 61. As the light emitting units 62, it may be possible to use light sources having substantially identical directivity, e.g., light bulbs, LEDs (Light Emitting Diodes) or laser light sources.

Further, it is not necessarily required that the light beams have same directivity as long as the light beams irradiated from the light emitting units 62 contain the measurement light beams L. The number of the light emitting units 62 may be an arbitrary number of four or more. The light emitting units 62 may be disposed at an arbitrary interval in the circumferential direction. If the light emitting units 62 are disposed at an equal interval, it is possible to further increase the accuracy of measurement of the position of the teaching jig 60. For example, the light emitting units 62 may be disposed such that the area of a polygon formed by interconnecting the positions of the light emitting units 62 becomes larger.

As shown in FIG. 3C, the body portion 61 may include a power supply unit 63 which supplies electric power to the light emitting units 62. This makes it possible to omit a wiring work to the light emitting units 62, thereby simplifying a teaching work. As the power supply unit 63, it may be possible to use, e.g., a battery or the like.

In FIG. 3C, there is illustrated a case where the power supply unit 63 is installed at one point of the body portion 61. However, the arrangement of the power supply unit 63 is not limiting thereto. For example, a plurality of power supply units 63 may be provided and each power supply unit 63 and each light emitting unit 62 may be provided to form a single unit. In FIG. 3C, there is illustrated a case where the body portion 61 is identical in shape with the wafer W. However, the shape of the body portion 61 is not limited to this illustration. The shape of the body portion 61 may be other shapes as long as the body portion 61 can be held on the hand 11 and can hold the light emitting units 62 at specified positions. In addition, the body portion 61 may have an arbitrary shape other than a plate shape.

In FIG. 3C, there is illustrated a case where the light emitting units 62 irradiate the measurement light beams L in an upward direction perpendicular to the major surface 61a of the body portion 61. However, the light emitting units 62 may be configured to irradiate the measurement light beams L in a downward direction perpendicular to the major surface 61a of the body portion 61. In this case, the arrangement positions of the light emitting units 62 and the shape of the hand 11 are appropriately decided such that the measurement light beams L is not blocked by the hand 11.

Next, the configuration of the teaching system according to the embodiment will be described with reference to FIG. 4. FIG. 4 is a block diagram of the teaching system according to the embodiment. In FIG. 4, there are shown only the components necessary for the description of the teaching system 1. Typical components are not shown in FIG. 4. The description made with reference to FIG. 4 will be focused on the configuration of the control device 50. In some cases, the description on the various kinds of devices shown in FIG. 2 will simplified.

As shown in FIG. 4, the control device 50 includes a control unit 51 and a memory unit 52. The control unit 51 includes an acquisition unit 51a, a determination unit 51b and an instruction unit 51c. The control unit 51 executes overall control of the control device 50. The acquisition unit 51a acquires information including a detection state of the measurement light beams L (see FIG. 3C) and a position of the hand 11 of the robot 10 which are detected by the detection unit 70, and transmits the information to the determination unit 51b.

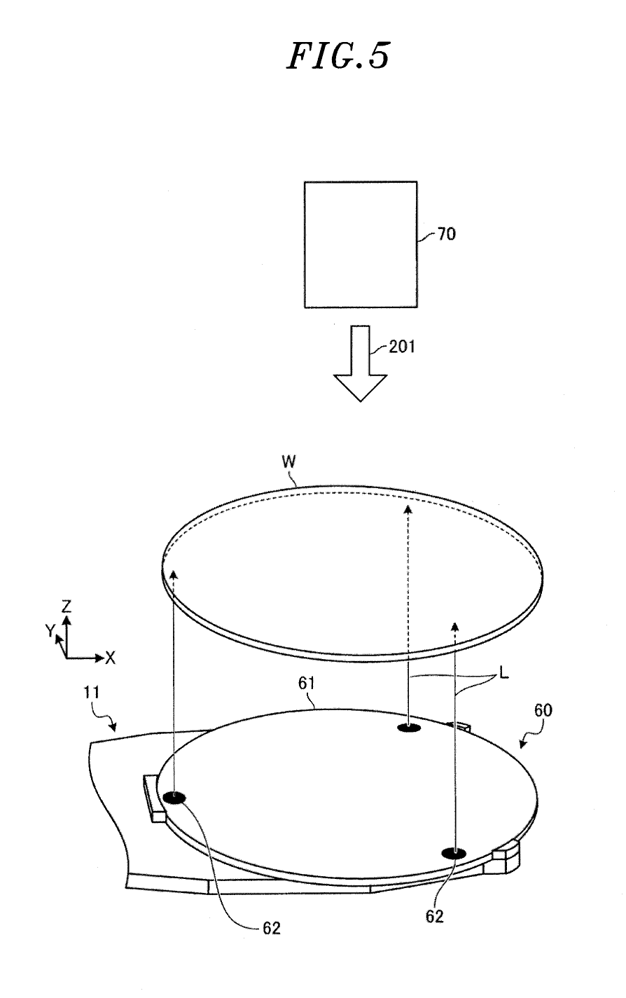

Now, one example of the teaching method which makes use of the teaching jig 60 will be described with reference to FIG. 5. FIG. 5 is a perspective view showing the teaching jig 60 located in the teaching position. The following description will be made by taking, as an example, a case where the teaching jig 60 is located just below the wafer W which has already been set in the FOUP 30 (see FIG. 2). In FIG. 5, there is illustrated the wafer W set in the FOUP 30 whose lower stages remain empty.

The robot 10 (see FIG. 3A) locates the hand 11 holding the teaching jig 60, e.g., at a specified Z-axis-direction position below the wafer W and then moves the hand 11 along the XY plane. While the hand 11 is moving in the XY plane, the detection unit 70 detects the measurement light beams L at the upper side of the wafer W (see an arrow 201 in FIG. 5).

If the teaching jig 60 is not located just below the wafer W, at least one measurement light beam L reaches the detection unit 70 without being blocked by the wafer W. On the other hand, if the teaching jig 60 is located just below the wafer W as shown in FIG. 5, all the measurement light beams L are blocked by the wafer W. Accordingly, the position where all the measurement light beams L are not detected may be regarded as a teaching position.

If the irradiation directions of the measurement light beams L are set in the downward direction perpendicular to the major surface 61a of the body portion 61 and if the detection unit 70 is configured to detect the measurement light beams L at the lower side of the wafer W, it is possible to locate the teaching jig 60 just above the wafer W.

In this way, if the measurement light beams L are irradiated in a direction perpendicular to the major surface 61a of the body portion 61, it is possible to easily locate the teaching jig 60 just below or just above the wafer W. Moreover, if light beams having directivity, such as laser beams or the like, are used as the measurement light beams L, an alignment work can be easily performed regardless of the distance from the teaching jig 60 to the detection unit 70.

The above description is directed to a case where the light emitting units 62 are installed at the inside of the peripheral edge of the body portion 61. However, if the light emitting units 62 are installed at the outside of the peripheral edge of the body portion 61, all the measurement light beams L are not blocked by the wafer W at the teaching position. Accordingly, the position where all the measurement light beams L are detected may be regarded as the teaching position.

In the present embodiment, even when the light emitting units 62 are installed at one of the inside and the outside of the peripheral edge of the body portion 61, it is possible to determine the teaching position based on a plurality of wafers W accommodated at multiple stages along the irradiation direction of the measurement light beam L.

Referring back to FIG. 4, the description on the control device 50 will go on. The determination unit 51b determines that when none of the measurement light beams L are detected by the detection unit 70, the position of the hand 11 is on the teaching position. The memory unit 52 stores the position information of the hand 11 in the teaching position as teaching information 52b.

The determination of the teaching position is executed based on determination information 52a. The determination information 52a is information including the light block states of the measurement light beams L at the teaching position and is previously stored in the memory unit 52. The teaching information 52b includes a “job” which is a program that actually operates the robot 10 according to a specific work such as a teaching work or the like. Based on the information transmitted from the teaching information 52b, the instruction unit 51c generates and outputs an operation signal for operating the robot 10.

The memory unit 52 is a memory device such as a hard disk drive or a nonvolatile memory and is configured to store the determination information 52a and the teaching information 52b. Since the contents of the determination information 52a and the teaching information 52b have been described above, no description will be made here.

In case where the light emitting units 62 (see FIG. 3C) are installed at the outside of the peripheral edge of the body portion 61, the determination unit 51b determines that when all the measurement light beams L are detected by the detection unit 70, the position of the hand 11 is the teaching position.

In the foregoing description, there is illustrated an example where the control device 50 executes determination on the position of the hand 11 based on the determination information 52a stored in advance. Alternatively, it may be possible to acquire, if necessary, information from a host device connected to the control device 50 in a mutually communicating manner.

In the foregoing description, the robot 10 moves the teaching jig 60 based on the teaching information 52b. However, the present disclosure is not limited thereto. The robot 10 may be operated by the instructions of a worker inputted through a specified input device.

In the foregoing description, the teaching position is determined based on the detection result of the detection unit 70. However, the present disclosure is not limited thereto. It may be possible to visually perform the detection of the measurement light beams L and to determine the teaching position.

If the positional relationship of the respective light emitting units 62 is predetermined with respect to the moving direction of the hand 11 in the teaching work, it becomes possible to further facilitate the teaching work. The following description will be made by taking, as an example, a case where the hand 11 is moved parallel to the X axis or the Y axis in the teaching work.

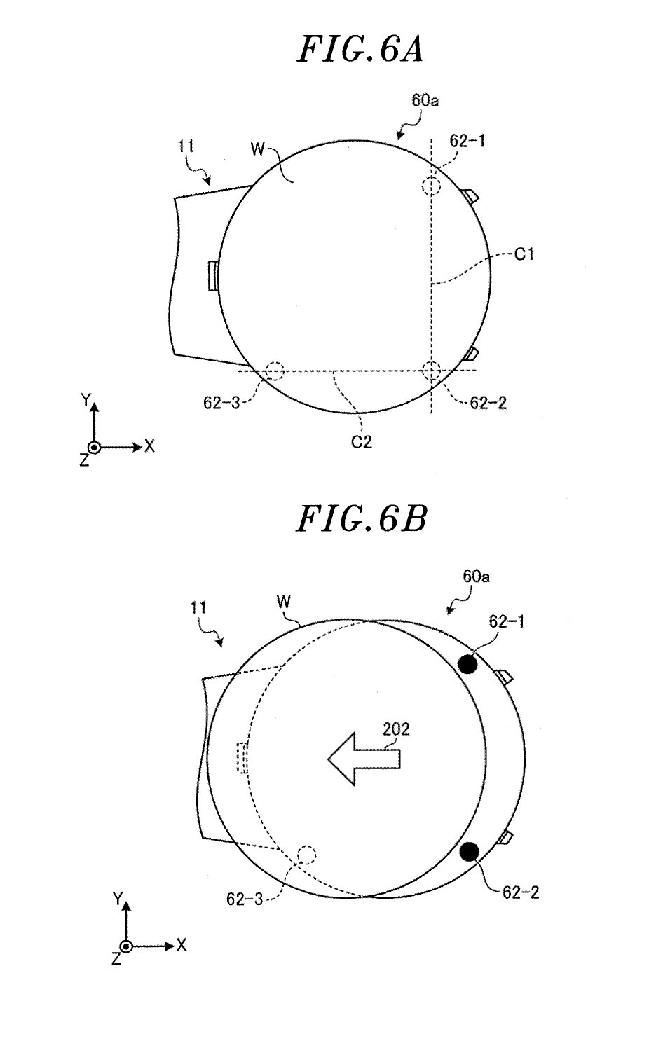

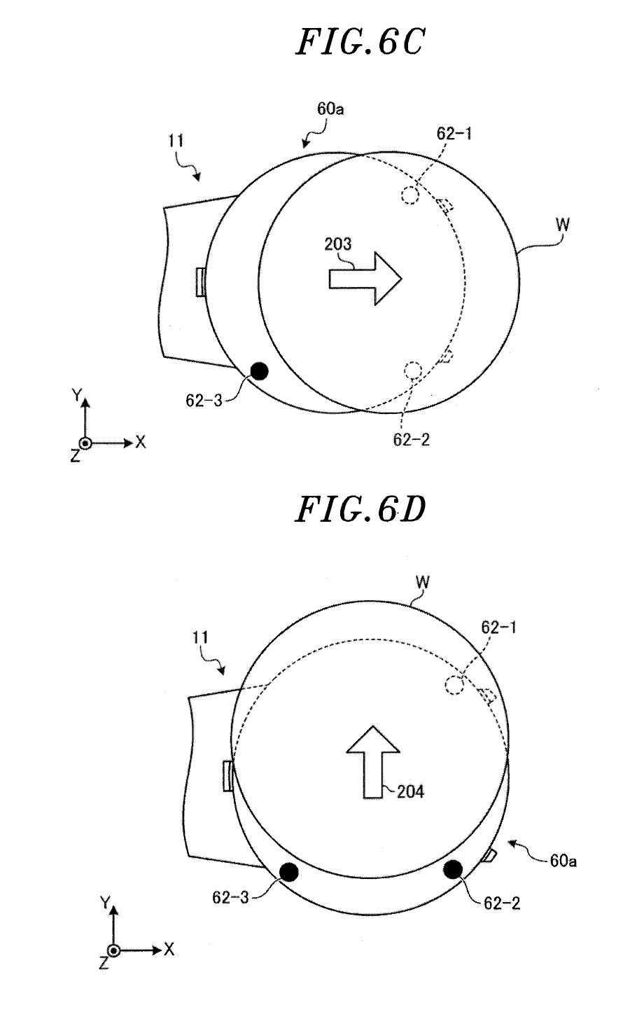

FIGS. 6A to 6D are explanatory views for explaining a teaching method which makes use of a teaching jig according to a first modified example. FIG. 6A shows the teaching jig 60a, the hand 11 and the wafer W at the teaching position, which are seen from the positive side of the Z axis.

As shown in FIG. 6A, in the teaching jig 60a according to the first modified example, a line C1 interconnecting the light emitting unit 62-1 and the light emitting unit 62-2 and a line C2 interconnecting the light emitting unit 62-2 and the light emitting unit 62-3 are orthogonal to each other.

The hand 11 holds the teaching jig 60a such that the line C1 is positioned at the tip side of the hand 11 and orthogonal to the X axis. In FIG. 6A, there is illustrated, by way of example, a case where the light emitting unit 62-3 is located at the negative side of the Y axis as compared to the light emitting unit 62-1. The teaching jig 60a may be held on the hand 11 in a specified positional relationship using, e.g., engagement portions or position marks not shown.

FIG. 6B illustrates a case where the hand 11 is located at the positive side of the X axis with respect to the teaching position. In this case, two measurement light beams L (see FIG. 3C) irradiated from the light emitting unit 62-1 and the light emitting unit 62-2 are detected by detection unit 70.

On the other hand, if the hand 11 is located at the negative side of the X axis with respect to the teaching position, only one measurement light beam L irradiated from the light emitting unit 62-3 is detected by detection unit 70. Accordingly, if two measurement light beams L are detected when the hand 11 is moved in the X-axis direction, it is presumed that the teaching position is located at the negative side of the X axis with respect to the position of the hand 11 (see an arrow 202 in FIG. 6B).

On the contrary, if one measurement light beam L is detected, it is presumed that the teaching position is located at the positive side of the X axis with respect to the position of the hand 11 (see an arrow 203 in FIG. 6C). Thus, it is possible to easily determine based on the number of the detected measurement light beams L whether to move the hand 11 toward the positive side or the negative side of the X axis.

FIG. 6D shows a case where the hand 11 moved in the Y-axis direction is located at the negative side of the Y-axis with respect to the teaching position. In this case, two measurement light beams L irradiated from the light emitting unit 62-2 and the light emitting unit 62-3 are detected by detection unit 70. While not shown in the drawings, if the hand 11 moved in the Y-axis direction is located at the positive side of the Y-axis with respect to the teaching position, one measurement light beam L irradiated from the light emitting unit 62-1 is detected by detection unit 70.

Accordingly, if the hand 11 is moving in the Y-axis direction and two measurement light beams L are detected, it is presumed that the teaching position is located at the positive side of the Y axis with respect to the position of the hand 11 (see an arrow 204 in FIG. 6D). On the other hand, if one measurement light beam L is detected, it is presumed that the teaching position is located at the negative side of the Y axis with respect to the position of the hand 11.

As described above, in the teaching jig 60a according to the first modified example, the light emitting units 62 are disposed such that a line interconnecting two of the three light emitting units 62 and a line interconnecting two of the three light emitting units 62 including the remaining one are orthogonal to each other. In addition, these lines correspond to the movement directions of the hand 11 (e.g., the X-axis direction and the Y-axis direction).

Thus, the positional relationship of the hand 11 with respect to the teaching position can be estimated based on the number of the detected measurement light beams L in each of the movement directions of the hand 11 during the teaching work, e.g., the X-axis direction and the Y-axis direction.

Accordingly, even if the hand 11 is positioned within, e.g., an apparatus or the like and is hardly recognizable with eyes, it is possible to easily move the hand 11 toward the teaching position based on the number of the detected measurement light beams L. It is only necessary that the two movement directions of the hand 11 are orthogonal to each other in a plane. It is not required that each of the two movement directions of the hand 11 is parallel to the X axis or the Y axis.

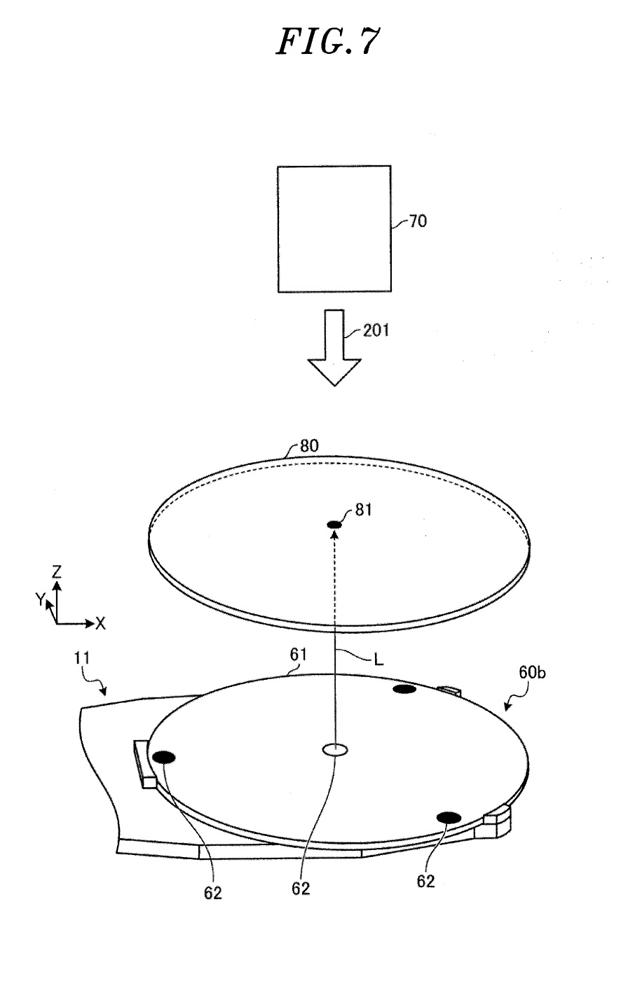

Next, a teaching jig according to a second modified example will be described with reference to FIG. 7. FIG. 7 is a perspective view showing a teaching jig according to the second modified example, which is located at a teaching position. As shown in FIG. 7, the teaching jig 60b according to the second modified example further includes a light emitting unit 62 disposed at the center of the major surface 61a of the body portion 61 (see a “white circle” in FIG. 7).

Instead of the wafer W (see FIG. 5) to be measured by the teaching jig 60b, a measurement member 80 is accommodated within the FOUP 30 (see FIG. 2). The measurement member 80 has a major surface identical in shape with the wafer W. The measurement member 80 is a transparent disc having a light blocking mark 81 positioned at the center of the major surface thereof.

Since the light emitting unit 62 is provided at the center of the major surface 61a of the body portion 61, the measurement light beam L irradiated from the light emitting unit 62 is blocked by the mark 81 when the teaching jig 60b is positioned at the teaching position. Thus, the teaching jig 60b can be located just below the measurement member 80 by aligning the central points of the major surfaces of the teaching jig 60b and the measurement member 80 with each other. This makes it possible to simplify the teaching work.

Furthermore, the measurement member 80 may be provided with a light-blocking portion near a peripheral edge thereof and the teaching position may be determined based on the light blocking states of a plurality of the light emitting units 62 including the one disposed at the center of the body portion 61. This makes it possible to increase the accuracy of alignment. The measurement member 80 may be a light-blocking member which has, e.g., a hole or a light-transmitting window formed at the center of the major surface thereof.

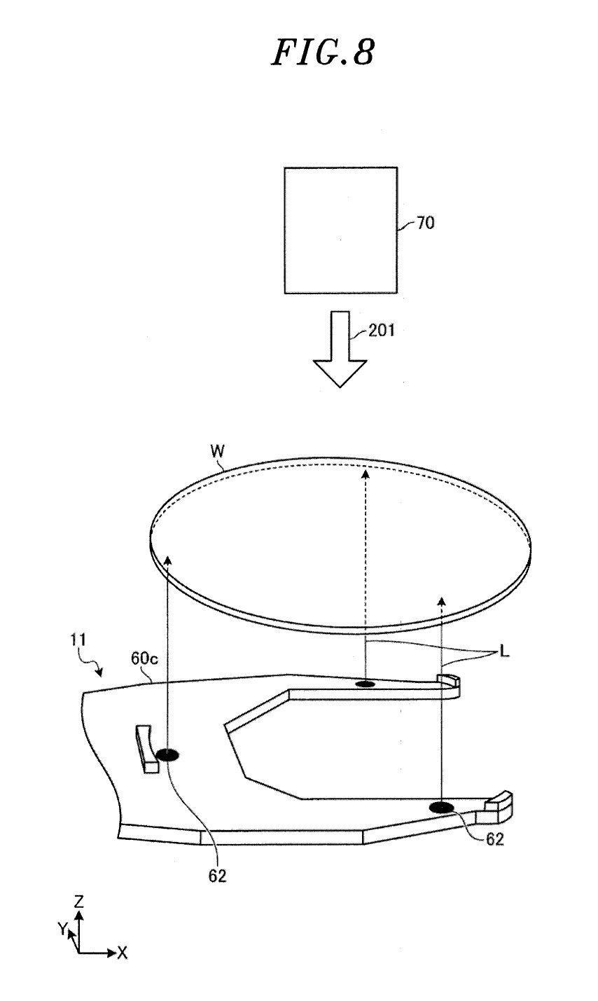

Next, a teaching jig according to a third modified example will be described with reference to FIG. 8. FIG. 8 is a perspective view showing a teaching jig according to the third modified example, which is located at a teaching position. As shown in FIG. 8, in the teaching jig 60c according to the third modified example, the light emitting units 62 are installed in the plate 11b of the hand 11 (see FIG. 3B) rather than the body portion 61 (see FIG. 3C).

This makes it possible to directly teach the teaching position of the hand 11 without having to hold a teaching jig. That is, in the third modified example, the hand 11 provided at the tip of the arm unit corresponds to the body portions of the teaching jigs of the above described embodiment and the modified examples. It is therefore possible to accurately perform a teaching operation while reducing the cost of equipment.

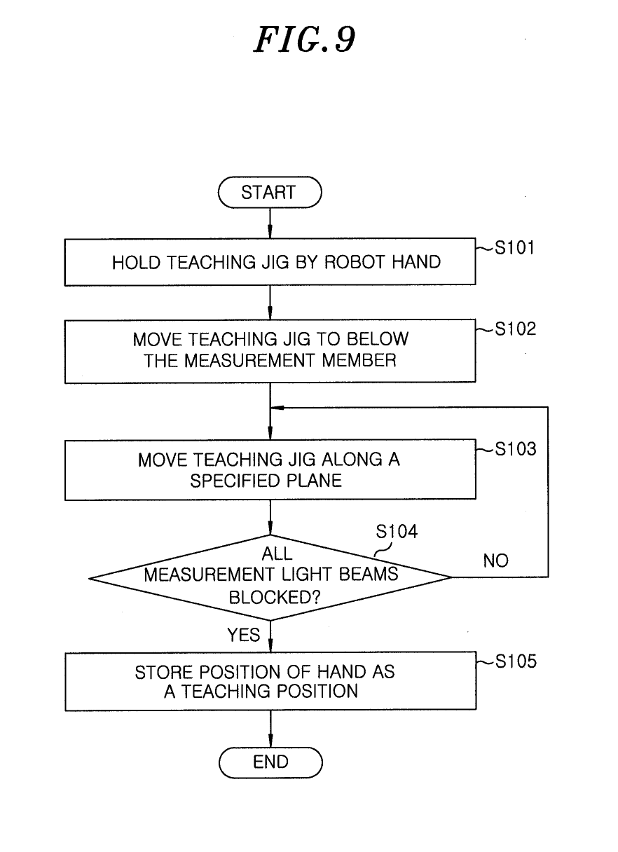

Next, a process sequence executed by the teaching system 1 according to the embodiment will be described with reference to FIG. 9. FIG. 9 is a flowchart illustrating a process sequence executed by the teaching system 1. Description will be made by taking, as an example, a case where the teaching jig 60 having the light emitting units 62 installed at the inside of the peripheral edge of the body portion 61 is located just below the wafer W.

As illustrated in FIG. 9, the robot 10 holds the teaching jig 60 with the hand 11 (step S101). The robot 10 moves the teaching jig 60 to below the measurement member 80 (or the wafer W) (step S102). Then, the robot 10 moves he teaching jig 60 along a specified plane, e.g., an XY plane (step S103).

The determination unit 51b determines whether all the measurement light beams L are blocked by the measurement member 80 (or the wafer W) (step S104). If all the measurement light beams L are blocked by the measurement member 80 (or the wafer W) (if “Yes” at step S104), the control device 50 stores the position of the hand 11 as a teaching position (step S105) and terminates the process. If at least one measurement light beam L is detected by the detection unit 70 (if “No” at step S104), the process of step S103 is repeated.

In case where the light emitting units 62 are installed at the outer side of the peripheral edge of the body portion 61, the determination unit 51b determines at step S104 whether all the measurement light beams L are detected by the detection unit 70. In this case, if all the measurement light beams L are detected, the flow proceeds to step S105. If at least one measurement light beam L is not detected, the process of step S103 is repeated.

As described above, the teaching jig according to one aspect of the present embodiment includes a body portion and at least three light emitting units. The light emitting units are installed in the body portion. When the body portion is seen over the measurement member, the light emitting units are positioned in the vicinity of the peripheral edge of the measurement member and at only one of the inside and the outside of the peripheral edge of the measurement member.

As described above, in the teaching jig according to the present embodiment, the light-blocking states of the light beams irradiated from all the light emitting units at the teaching position are identical with one another. Accordingly, the teaching jig according to the present embodiment makes it possible to efficiently perform the teaching work.

While the horizontal articulated robot has been described by way example in the aforementioned embodiment and the modified examples, it may be possible to use a multi-axis robot having an arbitrary number of axes. While the single-arm robot has been described by way of example in the aforementioned embodiment and the modified examples, the present disclosure may be applied to a dual-arm robot or a multi-arm robot. Alternatively, a plurality of hands may be installed at the tip portion of a single arm.

It should be understood by those skilled in the art that various modifications, combinations, sub-combinations and alterations may occur depending on design requirements and other factors insofar as they are within the scope of the appended claims or the equivalents thereof.

What is claimed is:

1. A teaching jig comprising:
a body portion; and
at least three light emitting units installed on the body portion,
wherein all the light emitting units are positioned, when the body portion is located at a target position of the teaching jig with respect to a measurement member and is seen over the measurement member, in the vicinity of a peripheral edge of the measurement member and at only one of the inside and the outside of the peripheral edge of the measurement member.

2. The teaching jig of claim 1, wherein the body portion includes a major surface on which all of the light emitting units are installed, and each of the light emitting units irradiates a light beam in a direction perpendicular to the major surface.

3. The teaching jig of claim 1, wherein each of the light emitting units includes a light source having substantially identical directivity.

4. The teaching jig of claim 2, wherein each of the light emitting units includes a light source having substantially identical directivity.

5. The teaching jig of claim 1, wherein the body portion includes a power supply unit provided at the body portion and configured to supply electric power to the light emitting units.

6. The teaching jig of claim 2, wherein the body portion includes a power supply unit provided at the body portion and configured to supply electric power to the light emitting units.

7. The teaching jig of claim 3, wherein the body portion includes a power supply unit provided at the body portion and configured to supply electric power to the light emitting units.

8. The teaching jig of claim 4, wherein the body portion includes a power supply unit provided at the body portion and configured to supply electric power to the light emitting units.

9. The teaching jig of claim 1, further comprising:
an additional light emitting unit which is positioned, when the body portion is located at the target position with respect to the measurement member and is seen over the measurement member, to overlap with a center of the measurement member.

10. The teaching jig of claim 2, further comprising:
an additional light emitting unit which is positioned, when the body portion is located at the target position with respect to the measurement member and is seen over the measurement member, to overlap with a center of the measurement member.

11. The teaching jig of claim 3, further comprising:
an additional light emitting unit which is positioned, when the body portion is located at the target position with respect to the measurement member and is seen over the measurement member, to overlap with a center of the measurement member.

12. The teaching jig of claim 4, further comprising:
an additional light emitting unit which is positioned, when the body portion is located at the target position with respect to the measurement member and is seen over the measurement member, to overlap with a center of the measurement member.

13. The teaching jig of claim 5, further comprising:
an additional light emitting unit which is positioned, when the body portion is located at the target position with respect to the measurement member and is seen over the measurement member, to overlap with a center of the measurement member.

14. The teaching jig of claim 6, further comprising:
an additional light emitting unit which is positioned, when the body portion is located at the target position with respect to the measurement member and is seen over the measurement member, to overlap with a center of the measurement member.

15. The teaching jig of claim 7, further comprising:
an additional light emitting unit which is positioned, when the body portion is located at the target position with respect to the measurement member and is seen over the measurement member, to overlap with a center of the measurement member.

16. The teaching jig of claim 8, further comprising:
an additional light emitting unit which is positioned, when the body portion is located at the target position with respect to the measurement member and is seen over the measurement member, to overlap with a center of the measurement member.

17. The teaching jig of claim 1, wherein the target position is, when the body portion is seen over the measurement member, a position of the teaching jig where light beams irradiated from all the light emitting units are blocked by the measurement member or a position of the teaching jig where none of the light beams irradiated from all the light emitting units are blocked by the measurement member.

18. A teaching system comprising the teaching jig of claim 1.

19. The teaching system of claim 18, further comprising:
a robot which has an arm provided with a hand at a tip portion of the arm, the teaching jig being held by the hand;
a detection unit configured to detect light beams irradiated from all the light emitting units; and
a robot controller configured to generate an operation signal for operating the robot and store as the target position, when the body portion is seen over the measurement member, a position of the teaching jig where the light beams irradiated from all the light emitting units are blocked by the measurement member or a position of the teaching jig where none of the light beams irradiated from all the light emitting units are blocked by the measurement member.

20. The teaching system of claim 18, further comprising:
a robot having an arm provided with the body portion at a tip portion of the arm, the body portion serving as a hand of the robot;
a detection unit configured to detect light beams irradiated from all the light emitting units; and
a robot controller configured to generate an operation signal for operating the robot and store as the target position, when the body portion is seen over the measurement member, a position of the body portion where the light beams irradiated from all the light emitting units are blocked by the measurement member or a position of the body portion where none of the light beams irradiated from all the light emitting units are blocked by the measurement member.

21. A teaching method comprising:
holding by a hand of a robot a teaching jig which includes a body portion and at least three light emitting units installed on the body portion, all the light emitting units being positioned, when the body portion is located at a target position of the teaching jig with respect to a measurement member and is seen over the measurement member, in the vicinity of a peripheral edge of the measurement member and at only one of the inside and the outside of the peripheral edge of the measurement member;
moving the hand with respect to the measurement member;
detecting light beams irradiated from all the light emitting units; and
storing as the target position, based on a result of the detection, a position of the teaching jig where the light beams irradiated from all the light emitting units are blocked by the measurement member or a position of the teaching jig where none of the light beams irradiated from all the light emitting units are blocked by the measurement member.
